(19) United States
(12) Patent Application Publication
(10) Pub. No.: US 2026/0044329 A1
(43) Pub. Date: Feb. 12, 2026

(54) FIRMWARE CODE LEVEL INSTRUCTION CERTIFICATION

(71) Applicant: INTERNATIONAL BUSINESS MACHINES CORPORATION, Armonk, NY (US)

(72) Inventors: Louis P. GOMES, Poughkeepsie, NY (US); Jonathan D. BRADBURY, Poughkeepsie, NY (US); Brenton BELMAR, New Paltz, NY (US); Timothy J. SLEGEL, Staatsburg, NY (US)

(21) Appl. No.: 18/799,392

(22) Filed: Aug. 9, 2024

(51) Int. Cl. G06F 8/61

(52) U.S. Cl. CPC G06F 8/61

(57) ABSTRACT

Execution of an instruction includes obtaining from an application program a request to execute of an instruction to perform an action defined by the instruction. Machine code accesses a function code in the instruction to locate a version number of firmware code of the instruction and a hash comprising a firmware code level of the instruction. Machine code locates the hash and the version number in a storage of the at least one computing device. Machine code provides the hash and the version number to the application program, wherein the application program issues the instruction if the hash is certified by a certification authority.

### BACKGROUND

One or more aspects relate, in general, to processing within a computing environment, and in particular, to instruction execution within the computing environment.

Instructions are issued by computer code or programs and executed by processors to perform certain actions (e.g., tasks, operations, functions, etc.). For instance, cryptographic instructions are used to implement cryptographic algorithms and perform cryptographic functions, which are used for the protection of data. There are a number of cryptographic functions, including various cryptographic hash functions, such as SHA-3 (Secure Hash Algorithm 3) and SHAKE (SHA Keccak), as examples, which may be used to protect data. SHAKE is a variable length hash function that is based on the Keccak algorithm.

Firmware includes, e.g., the microcode or millicode of a processor. It includes, for instance, the hardware-level instructions and/or data structures used in implementation of higher-level machine code. In one embodiment, it includes, for instance, proprietary code that is typically delivered as microcode or millicode that includes trusted software, microcode or millicode specific to the underlying hardware and controls operating system access to the system hardware.

### SUMMARY

Shortcomings of the prior art are overcome, and additional advantages are provided through the provision of a computer program product. The computer program product includes a set of one or more computer-readable storage media and program instructions, collectively stored in the set of one or more computer-readable storage media, for causing at least one computing device to perform computer operations. The computer operations include obtaining from an application program a request to execute of an instruction to perform an action defined by the instruction. The computer operations include accessing a function code in the instruction to locate a version number of firmware code of the instruction and a hash comprising a firmware code level of the instruction. The computer operations include locating the hash and the version number in secure storage of the at least one computing device. The computer operations include providing the hash and the version number to the application program, where the application program issues the instruction if the hash is certified by a certification authority.

Shortcomings of the prior art are overcome, and additional advantages are provided through the provision of a computer program product. The computer program product includes a set of one or more computer-readable storage media and program instructions, collectively stored in the set of one or more computer-readable storage media, for causing at least one computing device to perform computer operations. The computer operations include generating and installing a driver on the at least one computing device. Generating and installing the driver includes generating a list of code components utilized by an instruction at code release build time. Computer operations include locating the code components. Computer operations include generating a hash of the firmware code level of the instruction. Computer operations include assigning a version number of firmware code of the instruction to the hash at the code release build time. Computer operations include packaging the code components in the list, the hash, and the version number as a set of code components for the instruction in a package. Computer operations include generating the driver, where the driver comprises the package. Computer operations also include installing the driver on the at least one computing device.

Shortcomings of the prior art are overcome, and additional advantages are provided through the provision of a computer-implemented method. The method includes obtaining from an application program a request to execute of an instruction to perform an action defined by the instruction. The method includes accessing a function code in the instruction to locate a version number of firmware code of the instruction and a hash comprising a firmware code level of the instruction. The method includes locating the hash and the version number in secure storage of the at least one computing device. The method includes providing the hash and the version number to the application program, where the application program issues the instruction if the hash is certified by a certification authority.

Shortcomings of the prior art are overcome, and additional advantages are provided through the provision of a computer-implemented method. The method includes executing computer operations including generating and installing a driver on the at least one computing device, the generating and installing comprising. Generating and installing the driver includes generating a list of code components utilized by an instruction at code release build time. Computer operations include locating the code components. Computer operations include generating a hash of the firmware code level of the instruction. Computer operations include assigning a version number of firmware code of the instruction to the hash at the code release build time. Computer operations include packaging the code components in the list, the hash, and the version number as a set of code components for the instruction in a package. Computer operations include generating the driver, where the driver comprises the package. Computer operations also include installing the driver on the at least one computing device.

Shortcomings of the prior art are overcome, and additional advantages are provided through the provision of a system. The system includes: a memory, one or more processors in communication with the memory, and program instructions executable by the one or more processors via the memory to perform a method. The method includes obtaining from an application program a request to execute of an instruction to perform an action defined by the instruction. The method includes accessing a function code in the instruction to locate a version number of firmware code of the instruction and a hash comprising a firmware code level of the instruction. The method includes locating the hash and the version number in secure storage of the at least one computing device. The method includes providing the hash and the version number to the application program, where the application program issues the instruction if the hash is certified by a certification authority.

Shortcomings of the prior art are overcome, and additional advantages are provided through the provision of a system. The system includes: a memory, one or more processors in communication with the memory, and program instructions executable by the one or more processors via the memory to perform a method. The method includes executing computer operations including generating and installing a driver on the at least one computing device, the generating and installing comprising. Generating and installing the driver includes generating a list of code components utilized by an instruction at code release build time. Computer operations include locating the code components. Computer operations include generating a hash of the firmware code level of the instruction. Computer operations include assigning a version number of firmware code of the instruction to the hash at the code release build time. Computer operations include packaging the code components in the list, the hash, and the version number as a set of code components for the instruction in a package. Computer operations include generating the driver, where the driver comprises the package. Computer operations also include installing the driver on the at least one computing device.

Computer-implemented methods, computer systems and computer program products relating to one or more aspects are described and claimed herein. Each of the embodiments of the computer program product may be embodiments of each computer system and/or each computer-implemented method and vice-versa. Further, each of the embodiments is separable and optional from one another. Moreover, embodiments may be combined with one another. Each of the embodiments of the computer program product may be combinable with aspects and/or embodiments of each computer system and/or computer-implemented method, and vice-versa. Further, services relating to one or more aspects are also described and may be claimed herein.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to incorporate and use one or more aspects of the present disclosure;

FIG. 2 depicts one example of further details of a processor of the processor set of FIG. 1, in accordance with one or more aspects of the present disclosure;

FIG. 3A depicts one format of a Compute Digital Signature Authentication (KDSA) instruction, in accordance with an aspect of the present disclosure;

FIG. 3B depicts one example of a field of an implied register, general register 0, used by the instruction, in accordance with an aspect of the present disclosure;

FIG. 3C depicts one example of function codes supported by the instruction, in accordance with an aspect of the present disclosure;

FIG. 3D depicts one example of a field of an implied register, general register 1, used by the instruction, in accordance with an aspect of the present disclosure;

FIG. 3E depicts one example of contents of a register, R2, specified by the Compute Digital Signature Authentication instruction, in accordance with an aspect of the present disclosure;

FIG. 3F depicts one example of contents of a register, R2+1, used by the Compute Digital Signature Authentication instruction, in accordance with an aspect of the present disclosure;

FIG. 3G depicts one example of a parameter block for a function to authenticate a running instruction's firmware code level;

FIG. 4 depicts a workflow comprising various aspects in accordance with one or more aspects of the present disclosure;

FIG. 5 depicts a workflow comprising various aspects in accordance with one or more aspects of the present disclosure;

FIG. 6 depicts a workflow comprising various aspects in accordance with one or more aspects of the present disclosure;

FIGS. 7A-7B depict another example of a computing environment to incorporate and use one or more aspects of the present disclosure; and

FIG. 8 depicts a workflow comprising various aspects in accordance with one or more aspects of the present disclosure.

### DETAILED DESCRIPTION

In accordance with one or more aspects of the present disclosure, a capability is provided to facilitate processing within a computing environment. For instance, processing is facilitated by providing control mode processing, in which one execution mode of a plurality of execution modes is selected and used for processing. In one or more aspects, text of an instruction (e.g., a control mode indicator of the instruction) is used to selectively control processing of the instruction, including use of selected instruction areas (e.g., fields, bits, storage areas, etc.) used by the instruction.

In one or more aspects, certain instructions, such as architected cryptographic instructions that implement cryptographic algorithms and/or other types of instructions, are defined within an architecture to use selected instruction areas (such as bits or fields of registers (e.g., general registers)) for input and output information. In one example architecture, for security reasons, programs can only utilize a cryptographic instruction and its functions and/or commands when the firmware code level of the cryptographic instruction has been certified by an official certification authority. An application program will call an instruction and program code (e.g., software) will compare a hash from the instruction execution to a hash obtained from a certification authority (CA) and cease using the instruction if the hash is not certified. The machine itself does not cease executing an instruction if its firmware code level is not certified. Utilizing various aspects of the examples herein, to meet this requirement, for these programs to execute fully and effectively on computing systems, the programs (e.g., software executing on the system) verify the certification of the firmware level by utilizing an (e.g., single) enhanced instruction, described herein, to enable one or more processors (e.g., executing problem state software) of the computing system to utilize instructions certified by a certification authority. To provide this utility, in some examples, the one or more processors (which can also be understood as machine code or firmware) treat a hash as code components and bundle with other (actual) code components with special tagging to locate the hash code component sought quickly and efficiently.

In one or more aspects, a single instruction (e.g., a Central Processor Assist for Cryptographic Functions (CPACF) instruction such as cipher message, compute message) is provided to generate and return an instruction's firmware code level (IFCL). Other examples are possible.

In the examples herein, software, such as problem state software, executing on one or more processors (e.g., a software application program) can utilize an instruction to query the hash of the firmware level of the target (enhanced) instruction, which can be CPACF instructions, in the crypto certification library. Based on this query, the software can use only those CPACF instructions whose hash of the firmware level of the target CPACF instruction have been certified (e.g., by a certification authority). The program code (e.g., software) can compare a hash from an instruction execution to a hash obtained from a certification authority (CA) and can cease using the instruction if the hash is not certified.

One example of an instruction set architecture to incorporate aspects to enable program code executing on one or more processors to generate and return firmware level code of an instruction, which includes CPACF instructions, is the z/Architecture® instruction set architecture offered by International Business Machines Corporation, Armonk, New York. One embodiment of the z/Architecture instruction set architecture is described in a publication entitled, “z/Architecture Principles of Operation,” IBM Publication No. SA22-7832-13, Fourteenth Edition, May 2022, which is hereby incorporated herein by reference in its entirety. The z/Architecture instruction set architecture, however, is only one example architecture; other architectures and/or other types of computing environments of International Business Machines Corporation and/or of other entities/companies may include and/or use one or more aspects of the present disclosure. z/Architecture and IBM are trademarks or registered trademarks of International Business Machines Corporation in at least one jurisdiction.

In general, CPACF instructions can protect keys utilizing processor-based encryption. Specifically, CPACF instructions can provide processor-based encryption, which is well suited for bulk data encryption and is capable of performing a set of hashing and symmetric encryption functions using either clear keys or CPACF protected keys. Meanwhile, CPACF protected keys provide processor-based encryption utilizing system firmware as well as host operating system to ensure key material is not visible to an application program or host operating system.

Examples described herein include computer program products, computer systems, and computer-implemented methods where program code executing on one or more processors utilizes an instruction to generate and return the instruction's firmware code level (IFCL). In some examples, machine code generates a list of code components utilized by a target instruction at code release build time. The machine code locates the code components of the target instruction and generates a hash for the target instruction, assigns a version number, and can process the target instruction in the same manner as code components. The machine code can utilize special tagging to label elements in the hash for the target instruction so that the hash and the corresponding version number can be easily located. Upon generating the hash and the corresponding version number, the machine code can generate a machine firmware code (MFC) driver with the packaging information, including the special tagging, and release this package (e.g., bundle) to an MFC driver repository. By bundling the hash and the corresponding version number as code components with additional code components of the target instruction, program code executing on the machine and/or the machine code can treat the hash and the corresponding version number in the same manner as the real code components. A machine does not stop executing an instruction if its firmware code level is not certified. But once the MFC driver is installed on a machine, the program code (software) can compare a hash from the instruction execution to the hash it obtained from the CA and stop using instruction if the hash is not certified.

In the examples herein, the machine code can obtain certifications (from a CA) and can maintain a library of certifications for instructions. The machine code can transmit hashes of each target instruction to be certified to a certification authority. The machine code generates and maintains this hash library, which can contain the hashes and corresponding version numbers for each of the target instruction's firmware code levels (IFCLs) for supported machine models at the code release build time. The hash library is not part of the driver package which is discussed herein. The hash library is located in the firmware code library and not on the machine storage. The machine code can install the hash and the corresponding version number of the firmware code of the target instruction to the machine while preserving the special tagging. Responsive to receiving a query and/or a query authentication function from program code (e.g., software or an application program) executing on a machine upon which the driver was installed, the machine code can locate and return to the program code of the software application program, the hash and the corresponding version number of the firmware code of the specified instruction in the machine, using the special tagging.

The examples described herein, including computer-implemented methods, computer systems and computer program products are inextricably tied to computing and are directed to a practical application. Regarding the latter, a certification requirement requires that programs can use only cryptographic instructions and functions/commands of those instructions whose firmware code level of the cryptographic instruction have been certified by an official certification authority. In the examples herein, based on modifying firmware, a function is added to instructions to generate and return the instruction's firmware code level hash and its version number. Thus, for instructions augmented in this manner, machine code or program code (depending on the activity as describe herein) can: 1) query a hash of a firmware level of each instruction; 2) compare the hash against the hash of the firmware level of the target instruction in a crypto certification library (maintained by the firmware manager); and/or 3) utilize/execute instructions where the hash of the firmware level of the target instruction has been certified. The examples herein are inextricably tied to computing at least because firmware code and changes to storage of values in registers are inextricably tied to computing, as are modifying and executing machine instructions.

The examples herein provide significantly more to other approaches of meeting certification requirements for enabling software to utilize cryptographic instructions and their functions and/or commands only when these instructions have been certified by a certification authority. Utilizing a single machine instruction to obtain certification data and treating a hash and the corresponding version number as code components (in concert with actual or real code components) is a streamlined and efficient process that unlike in existing approaches, does not rely on mechanisms outside of the instructions themselves to locate the hash and version number and to see if software can have access to an instruction (based on it being certified). The examples herein determine quickly if an instruction is certified and can be utilized by software executing on a machine by efficiently utilizing existing structure within the firmware architecture.

In some examples herein, storing and providing an instruction's firmware code level as a hash enables this value to be identified easily instead of searching all of an instruction's firmware code components in an attempt to identify changes. Additionally, the examples herein provide certification information for a target instruction, including a hash and the corresponding version number of the firmware code, rather than providing one hash and a corresponding version number of the firmware code for all cryptographic instructions. By generating, storing, and providing this targeted information, the examples herein enable a program to be certification compliant for cases when the program does not use all cryptographic instructions in an instruction set or package but instead, uses only those cryptographic instructions that are certification compliant. As will be discussed herein, it is the hash that is certified by a certification authority (or not). The version number is utilized for debugging or troubleshooting and is useful for this purpose.

The examples herein take advantage of existing architecture features rather than increase system overhead by treating the hash and the version number as code components of the target instruction, eliminating special handling of the non-code components. As discussed herein, the hash and version information, which are not traditional code components of an instruction, are treated in the same manner as the code components of the instruction.

The version number is not part of the hash that is described herein, and this version number can provide assistance to a debugger that cannot be provided by the hash. By providing a version number of the instruction responsive to a program query, the program code can report the version number, if it changes while the program is running on the machine, in the error output. This aspect adds a debugging feature and can aid a debugger in determining that a concurrent driver upgrade or downgrade (e.g., microcode level) action took place. Additionally, machine code in certain of the examples herein create and maintain a hash store which includes hashes and corresponding version numbers for each instruction's firmware code levels, for all the supported machine models. This store or repository serves to maintain a history of a machine's firmware changes over time, which can be used to aid debugging the hash and/or the corresponding version number mismatch. This aspect is also beneficial to the health of a computing system because the error hash and corresponding version numbers of the target instruction's firmware code level can be searched in the hash store to determine if the hash was created and injected by a malicious program.

The examples herein generate and store data in a consistent manner which assists in providing reliable instruction firmware level information. For example, the machine code in certain of the examples herein maintains special tagging for each hash and its version number code components through all the stages of the process, thus enabling a machine's firmware to easily locate and return them to a program (e.g., based on receiving a query).

The examples herein include computer program products that comprise a set of one or more computer-readable storage media, and program instructions, collectively stored in the set of one or more computer-readable storage media, for causing at least one computing device to perform computer operations. The computer operations include obtaining from an application program a request to execute of an instruction to perform an action defined by the instruction. The computer operations include accessing a function code in the instruction to locate a version number of firmware code of the instruction and a hash comprising a firmware code level of the instruction. The computer operations include locating the hash and the version number in a storage of the at least one computing device. The computer operation include providing the hash and the version number to the application program, wherein the application program issues the instruction if the hash is certified by a certification authority. These examples take advantage of existing architecture features rather than increase system overhead by treating the hash and the version number as code components of the target instruction, eliminating special handling of the non-code components.

Additionally or alternatively, locating the hash and the version number comprises utilizing tagging. This tagging enables the machine code to locate the hash and version number with ease so that the application code can determine whether the instruction is certified.

Additionally or alternatively, the instruction comprises a cryptographic instruction. Being able to determine quickly if an instruction is certified can be utilized by software executing on a machine by efficiently utilizing existing structure within the firmware architecture.

Additionally or alternatively, the computer operations include prior to obtaining the application program request, installing a driver on the at least one computing device. Installing the driver enables treating the hash and the version number as code components of the target instruction, eliminating special handling of the non-code components to enable an application issuing an instruction to evaluate whether the instruction is certified quickly and with minimal processing overhead.

Additionally or alternatively, the computer operations can include prior to installing the driver, generating the driver. Generating the driver includes generating a list of code components utilized by the instruction at code release build time. Generating the driver includes locating the code components. Generating the driver includes generating the hash of the firmware code level of the instruction. Generating the driver includes assigning the version number of firmware code of the instruction to the hash at the code release build time. Generating the driver includes packaging the code components in the list, the hash, and the version number as a set of code components for the instruction in a package. The driver comprises a package. Generating the driver includes installing the driver on the at least one computing device. Installing the driver enables treating the hash and the version number as code components of the target instruction, eliminating special handling of the non-code components which enables certification information to be conveyed in a manner encouraging systems continuity.

Additionally or alternatively, the package comprises tagging to indicate a location of the hash, and a location of the version number in the set of code components. The use of tagging allows this information to be located quickly and efficiently.

Additionally or alternatively, the driver comprises a package and wherein installing the driver further comprises preserving tagging in the package at install, where the tagging indicates a location of the hash, and a location of the version number in the set of code components. Preserving tagging at install and then utilizing it during application runtime allows this information to be located quickly and efficiently and creates system consistency.

Additionally or alternatively, locating the hash and the version number comprises utilizing the tagging. The use of tagging allows this information to be located quickly and efficiently.

Additionally or alternatively, the computer operations can include retaining the hash and the version number in a list of a plurality of cryptographic instructions and firmware code level hashes and firmware version numbers for the plurality of cryptographic instructions, where the instruction is a cryptographic instruction. This store or repository serves to maintain a history of a machine's firmware changes over time, which can be used to aid debugging the hash and/or the corresponding version number mismatch. This aspect is also beneficial to the health of a computing system because the error hash and corresponding version numbers of the target instruction's firmware code level can be searched in the hash store to determine if the hash was created and injected by a malicious program.

Additionally or alternatively, the computer operations can include transmitting a portion of the firmware code level hashes of the plurality of cryptographic instructions to a certification authority. The integration of the certification and enabling the application ultimately to receive this information by utilizing existing elements of the system infrastructure minimizes impacts on processing time and promotes system consistency and continuity.

Additionally or alternatively, the computer operations can include maintaining firmware code level hashes and firmware version numbers for the plurality of cryptographic instructions in a library. Retaining these data create a record that can be utilized for debugging.

Additionally or alternatively, the computer operations further can include obtaining a query authentication information function for the instruction. The computer operations can include locating the hash and the version number of the instruction. The computer operations can include responding to the function with the hash and the version number. Enabling the computer operations to authenticate information related to the function enhances system security and data integrity.

Additionally or alternatively, the driver comprises a machine firmware code driver. Installing the driver enables treating the hash and the version number as code components of the target instruction, eliminating special handling of the non-code components to enable an application issuing an instruction to evaluate whether the instruction is certified quickly and with minimal processing overhead.

Additionally or alternatively, the instruction comprises a Central Processor Assist Cryptographic Facility instruction. Being able to determine quickly if an instruction is certified can be utilized by software executing on a machine by efficiently utilizing existing structure within the firmware architecture.

Additionally or alternatively, the computer operations include determining if the hash was created by a rogue program. Determining if the hash was created by a rogue program can include obtaining as input an error hash. This determining can include searching the library for a match. This determining can include returning an outcome of the searching. This aspect assists in maintaining the integrity of the system.

The examples herein can include computer systems that include at least one computing device, a set of one or more computer-readable storage media, and program instructions, collectively stored in the set of one or more computer-readable storage media, for causing the at least one computing device to perform computer operations. The computer operations include obtaining from an application program a request to execute of an instruction to perform an action defined by the instruction. The computer operations include accessing a function code in the instruction to locate a version number of firmware code of the instruction and a hash comprising a firmware code level of the instruction. The computer operations include locating the hash and the version number in a storage of the at least one computing device. The computer operation include providing the hash and the version number to the application program, wherein the application program issues the instruction if the hash is certified by a certification authority. These examples take advantage of existing architecture features rather than increase system overhead by treating the hash and the version number as code components of the target instruction, eliminating special handling of the non-code components.

Additionally or alternatively, locating the hash and the version number comprises utilizing tagging. This tagging enables the machine code to locate the hash and version number with ease so that the application code can determine whether the instruction is certified.

Additionally or alternatively, the instruction comprises a cryptographic instruction. Being able to determine quickly if an instruction is certified can be utilized by software executing on a machine by efficiently utilizing existing structure within the firmware architecture.

Additionally or alternatively, the computer operations include prior to obtaining the application program request, installing a driver on the at least one computing device. Installing the driver enables treating the hash and the version number as code components of the target instruction, eliminating special handling of the non-code components to enable an application issuing an instruction to evaluate whether the instruction is certified quickly and with minimal processing overhead.

Additionally or alternatively, the computer operations can include prior to installing the driver, generating the driver. Generating the driver includes generating a list of code components utilized by the instruction at code release build time. Generating the driver includes locating the code components. Generating the driver includes generating the hash of the firmware code level of the instruction. Generating the driver includes assigning the version number of firmware code of the instruction to the hash at the code release build time. Generating the driver includes packaging the code components in the list, the hash, and the version number as a set of code components for the instruction in a package. The driver comprises a package. Generating the driver includes installing the driver on the at least one computing device. Installing the driver enables treating the hash and the version number as code components of the target instruction, eliminating special handling of the non-code components which enables certification information to be conveyed in a manner encouraging systems continuity.

Additionally or alternatively, the package comprises tagging to indicate a location of the hash, and a location of the version number in the set of code components. The use of tagging allows this information to be located quickly and efficiently.

Additionally or alternatively, the driver comprises a package and wherein installing the driver further comprises preserving tagging in the package at install, where the tagging indicates a location of the hash, and a location of the version number in the set of code components. Preserving tagging at install and then utilizing it during application runtime allows this information to be located quickly and efficiently and creates system consistency.

Additionally or alternatively, locating the hash and the version number comprises utilizing the tagging. The use of tagging allows this information to be located quickly and efficiently.

Additionally or alternatively, the computer operations can include retaining the hash and the version number in a list of a plurality of cryptographic instructions and firmware code level hashes and firmware version numbers for the plurality of cryptographic instructions, where the instruction is a cryptographic instruction. This store or repository serves to maintain a history of a machine's firmware changes over time, which can be used to aid debugging the hash and/or the corresponding version number mismatch. This aspect is also beneficial to the health of a computing system because the error hash and corresponding version numbers of the target instruction's firmware code level can be searched in the hash store to determine if the hash was created and injected by a malicious program.

Additionally or alternatively, the computer operations can include transmitting a portion of the firmware code level hashes of the plurality of cryptographic instructions to a certification authority. The integration of the certification and enabling the application ultimately to receive this information by utilizing existing elements of the system infrastructure minimizes impacts on processing time and promotes system consistency and continuity.

Additionally or alternatively, the computer operations can include maintaining firmware code level hashes and firmware version numbers for the plurality of cryptographic instructions in a library. Retaining these data create a record that can be utilized for debugging.

Additionally or alternatively, the computer operations further can include obtaining a query authentication information function for the instruction. The computer operations can include locating the hash and the version number of the instruction. The computer operations can include responding to the function with the hash and the version number. Enabling the computer operations to authenticate information related to the function enhances system security and data integrity.

Additionally or alternatively, the driver comprises a machine firmware code driver. Installing the driver enables treating the hash and the version number as code components of the target instruction, eliminating special handling of the non-code components to enable an application issuing an instruction to evaluate whether the instruction is certified quickly and with minimal processing overhead.

Additionally or alternatively, the instruction comprises a Central Processor Assist Cryptographic Facility instruction. Being able to determine quickly if an instruction is certified can be utilized by software executing on a machine by efficiently utilizing existing structure within the firmware architecture.

Additionally or alternatively, the computer operations include determining if the hash was created by a rogue program. Determining if the hash was created by a rogue program can include obtaining as input an error hash. This determining can include searching the library for a match. This determining can include returning an outcome of the searching. This aspect assists in maintaining the integrity of the system.

The examples herein include computer-implemented methods that include requesting execution of an instruction to perform an action defined by the instruction. Executing the instruction includes. The method includes accessing a function code in the instruction to locate a version number of firmware code of the instruction and a hash comprising a firmware code level of the instruction. The method includes locating the hash and the version number in a storage of the at least one computing device. The computer operation include providing the hash and the version number to the application program, wherein the application program issues the instruction if the hash is certified by a certification authority. These examples take advantage of existing architecture features rather than increase system overhead by treating the hash and the version number as code components of the target instruction, eliminating special handling of the non-code components.

Additionally or alternatively, locating the hash and the version number comprises utilizing tagging. This tagging enables the machine code to locate the hash and version number with ease so that the application code can determine whether the instruction is certified.

Additionally or alternatively, the instruction comprises a cryptographic instruction. Being able to determine quickly if an instruction is certified can be utilized by software executing on a machine by efficiently utilizing existing structure within the firmware architecture.

Additionally or alternatively, the method can include, prior to obtaining the application program request, installing a driver on the at least one computing device. Installing the driver enables treating the hash and the version number as code components of the target instruction, eliminating special handling of the non-code components to enable an application issuing an instruction to evaluate whether the instruction is certified quickly and with minimal processing overhead.

Additionally or alternatively, the method can include prior to installing the driver, generating the driver. Generating the driver includes generating a list of code components utilized by the instruction at code release build time. Generating the driver includes locating the code components. Generating the driver includes generating the hash of the firmware code level of the instruction. Generating the driver includes assigning the version number of firmware code of the instruction to the hash at the code release build time. Generating the driver includes packaging the code components in the list, the hash, and the version number as a set of code components for the instruction in a package. The driver comprises a package. Generating the driver includes installing the driver on the at least one computing device. Installing the driver enables treating the hash and the version number as code components of the target instruction, eliminating special handling of the non-code components which enables certification information to be conveyed in a manner encouraging systems continuity.

Additionally or alternatively, the package comprises tagging to indicate a location of the hash, and a location of the version number in the set of code components. The use of tagging allows this information to be located quickly and efficiently.

Additionally or alternatively, the driver comprises a package and wherein installing the driver further comprises preserving tagging in the package at install, where the tagging indicates a location of the hash, and a location of the version number in the set of code components. Preserving tagging at install and then utilizing it during application runtime allows this information to be located quickly and efficiently and creates system consistency.

Additionally or alternatively, locating the hash and the version number comprises utilizing the tagging. The use of tagging allows this information to be located quickly and efficiently.

Additionally or alternatively, the method can include retaining the hash and the version number in a list of a plurality of cryptographic instructions and firmware code level hashes and firmware version numbers for the plurality of cryptographic instructions, where the instruction is a cryptographic instruction. This store or repository serves to maintain a history of a machine's firmware changes over time, which can be used to aid debugging the hash and/or the corresponding version number mismatch. This aspect is also beneficial to the health of a computing system because the error hash and corresponding version numbers of the target instruction's firmware code level can be searched in the hash store to determine if the hash was created and injected by a malicious program.

Additionally or alternatively, the method can include transmitting a portion of the firmware code level hashes of the plurality of cryptographic instructions to a certification authority. The integration of the certification and enabling the application ultimately to receive this information by utilizing existing elements of the system infrastructure minimizes impacts on processing time and promotes system consistency and continuity.

Additionally or alternatively, the method can include maintaining firmware code level hashes and firmware version numbers for the plurality of cryptographic instructions in a library. Retaining these data create a record that can be utilized for debugging.

Additionally or alternatively, the method further can include obtaining a query authentication information function for the instruction. The method can include locating the hash and the version number of the instruction. The method can include responding to the function with the hash and the version number. Enabling the method to authenticate information related to the function enhances system security and data integrity.

Additionally or alternatively, the driver comprises a machine firmware code driver. Installing the driver enables treating the hash and the version number as code components of the target instruction, eliminating special handling of the non-code components to enable an application issuing an instruction to evaluate whether the instruction is certified quickly and with minimal processing overhead.

Additionally or alternatively, the instruction comprises a Central Processor Assist Cryptographic Facility instruction. Being able to determine quickly if an instruction is certified can be utilized by software executing on a machine by efficiently utilizing existing structure within the firmware architecture.

Additionally or alternatively, the method includes determining if the hash was created by a rogue program. Determining if the hash was created by a rogue program can include obtaining as input an error hash. This determining can include searching the library for a match. This determining can include returning an outcome of the searching. This aspect assists in maintaining the integrity of the system.

The examples herein include computer program products that comprise a set of one or more computer-readable storage media, and program instructions, collectively stored in the set of one or more computer-readable storage media, for causing at least one computing device to perform computer operations. The computer operations can include generating and installing a driver on the at least one computing device. The generating and installing can include generating a list of code components utilized by an instruction at code release build time. The generating and installing can include locating the code components. The generating and installing can include generating a hash of the firmware code level of the instruction. The generating and installing can include assigning a version number of firmware code of the instruction to the hash at the code release build time. The generating and installing can include packaging the code components in the list, the hash, and the version number as a set of code components for the instruction in a package. The generating and installing can include generating the driver, where the driver comprises the package. The generating and installing can include installing the driver on the at least one computing device. Treating hashes as code components and bundling the hash code components with other (actual) code components with special tagging enables locating the hash code component sought quickly and efficiently.

Additionally or alternatively, the computer operations can include obtaining from an application a request to execute of an instruction to perform an action defined by the instruction. The computer operations can include accessing a function code in the instruction to locate a version number of firmware code of the instruction and a hash comprising a firmware code level of the instruction. The computer operations can include locating the hash and the version number in secure storage of the at least one computing device. The computer operations can include providing the hash and the version number to the application, wherein the application executes the instruction if the hash is certified by a certification authority. These examples take advantage of existing architecture features rather than increase system overhead by treating the hash and the version number as code components of the target instruction, eliminating special handling of the non-code components.

Additionally or alternatively, the instruction can comprise a cryptographic instruction. Being able to determine quickly if an instruction is certified can be utilized by software executing on a machine by efficiently utilizing existing structure within the firmware architecture.

The examples herein can include computer systems that include at least one computing device, a set of one or more computer-readable storage media, and program instructions, collectively stored in the set of one or more computer-readable storage media, for causing the at least one computing device to perform computer operations. The computer operations can include generating and installing a driver on the at least one computing device. The generating and installing can include generating a list of code components utilized by an instruction at code release build time. The generating and installing can include locating the code components. The generating and installing can include generating a hash of the firmware code level of the instruction. The generating and installing can include assigning a version number of firmware code of the instruction to the hash at the code release build time. The generating and installing can include packaging the code components in the list, the hash, and the version number as a set of code components for the instruction in a package. The generating and installing can include generating the driver, where the driver comprises the package. The generating and installing can include installing the driver on the at least one computing device. Treating hashes as code components and bundling the hash code components with other (actual) code components with special tagging enables locating the hash code component sought quickly and efficiently.

Additionally or alternatively, the computer operations can include obtaining from an application a request to execute of an instruction to perform an action defined by the instruction. The computer operations can include accessing a function code in the instruction to locate a version number of firmware code of the instruction and a hash comprising a firmware code level of the instruction. The computer operations can include locating the hash and the version number in secure storage of the at least one computing device. The computer operations can include providing the hash and the version number to the application, wherein the application executes the instruction if the hash is certified by a certification authority. These examples take advantage of existing architecture features rather than increase system overhead by treating the hash and the version number as code components of the target instruction, eliminating special handling of the non-code components.

Additionally or alternatively, the instruction can comprise a cryptographic instruction. Being able to determine quickly if an instruction is certified can be utilized by software executing on a machine by efficiently utilizing existing structure within the firmware architecture.

The examples herein can include computer-implemented methods that include generating and installing a driver on the at least one computing device. The methods can include generating and installing can include generating a list of code components utilized by an instruction at code release build time. The generating and installing can include locating the code components. The generating and installing can include generating a hash of the firmware code level of the instruction. The generating and installing can include assigning a version number of firmware code of the instruction to the hash at the code release build time. The generating and installing can include packaging the code components in the list, the hash, and the version number as a set of code components for the instruction in a package. The generating and installing can include generating the driver, where the driver comprises the package. The generating and installing can include installing the driver on the at least one computing device. Treating hashes as code components and bundling the hash code components with other (actual) code components with special tagging enables locating the hash code component sought quickly and efficiently.

Additionally or alternatively, the method can include obtaining from an application a request to execute of an instruction to perform an action defined by the instruction. The method can include accessing a function code in the instruction to locate a version number of firmware code of the instruction and a hash comprising a firmware code level of the instruction. The method can include locating the hash and the version number in secure storage of the at least one computing device. The method can include providing the hash and the version number to the application, wherein the application executes the instruction if the hash is certified by a certification authority. These examples take advantage of existing architecture features rather than increase system overhead by treating the hash and the version number as code components of the target instruction, eliminating special handling of the non-code components.

Additionally or alternatively, the instruction can comprise a cryptographic instruction. Being able to determine quickly if an instruction is certified can be utilized by software executing on a machine by efficiently utilizing existing structure within the firmware architecture.

Computer-implemented methods, computer systems and computer program products relating to one or more aspects are described and claimed herein. Each of the embodiments of the computer program product may be embodiments of each computer system and/or each computer-implemented method and vice-versa. Further, each of the embodiments is separable and optional from one another. Moreover, embodiments may be combined with one another. Each of the embodiments of the computer program product may be combinable with aspects and/or embodiments of each computer system and/or computer-implemented method, and vice-versa.

One or more aspects of the present disclosure are incorporated in, performed and/or used by a computing environment. As examples, the computing environment may be of various architectures and of various types, including, but not limited to: personal computing, client-server, distributed, virtual, emulated, partitioned, non-partitioned, cloud-based, quantum, grid, time-sharing, cluster, peer-to-peer, wearable, mobile, having one node or multiple nodes, having one processor or multiple processors, and/or any other type of environment and/or configuration, etc. that is capable of executing a process (or multiple processes) that performs control mode processing including selective control mode processing and/or one or more other aspects of the present disclosure. Aspects of the present disclosure are not limited to a particular architecture or environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

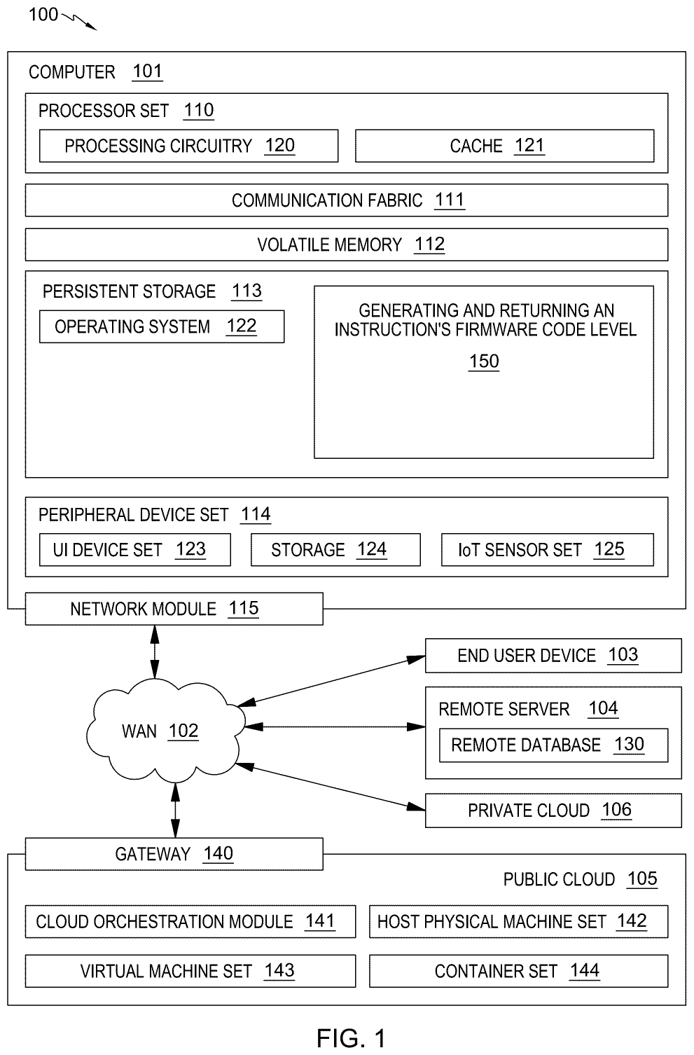

One example of a computing environment to perform, incorporate and/or use one or more aspects of the present disclosure is described with reference to FIG. 1. In one example, a computing environment 100 contains an example of an environment for the execution of at least some of the computer code involved in performing the inventive methods, such as generating and returning an instruction's firmware code level 150 (also referred to herein as block 150). In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images. ” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Cloud computing services and/or microservices (not separately shown in FIG. 1): private and public clouds 106, 105 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The computing environment described above is only one example of a computing environment to incorporate, perform and/or use one or more aspects of the present disclosure. Other examples are possible. For instance, in one or more embodiments, one or more of the components/modules/blocks of FIG. 1 are not included in the computing environment and/or are not used for one or more aspects of the present disclosure. Further, in one or more embodiments, additional and/or other components/modules/blocks may be used. Other variations are possible.

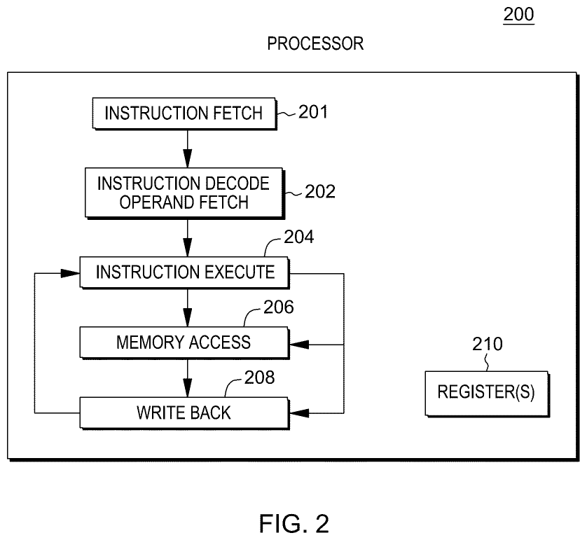

In one example, a processor (e.g., of processor set 110) includes a plurality of functional components (or a subset thereof) used to execute instructions. As depicted in FIG. 2, in one example, a processor 200 includes, for instance, an instruction fetch component 201 to fetch instructions to be executed; an instruction decode/operand fetch component 202 to decode the fetched instructions and to obtain operands of the decoded instructions; one or more instruction execute components 204 to execute the decoded instructions; a memory access component 206 to access memory for instruction execution, if necessary; and a write back component 208 to provide the results of the executed instructions. One or more of the components may access and/or use one or more registers 210 in instruction processing. Further, one or more of the components may access and/or use processing code to generate and return an instruction's firmware code level 150. Additionally, fewer, and/or other components may be used in one or more aspects of the present disclosure.

In one example, processing code includes code to generate and return an IFCL has and version number. The code is, e.g., computer-readable program code (e.g., instructions) in computer-readable storage media, e.g., storage (persistent storage 113, cache 121, storage 124, other storage, as examples). The computer-readable storage media may be part of one or more computer program products and the computer-readable program code may be executed by and/or using one or more computing devices (e.g., one or more computers, such as computer(s) 101 and/or other computers; one or more servers, such as remote server(s) 104 and/or other remote servers; one or more devices, such as end user device(s) 103 and/or other end user devices; one or more processors or nodes, such as processor(s) or node(s) of processor set 110 (e.g., processor 200) and/or other processor(s) or node(s); processing circuitry, such as processing circuitry 120 of processor set 110 and/or other processing circuitry; one or more hardware accelerators separate and/or part of one or more processors and/or processing circuitry; and/or other computing devices, etc.). Additional and/or other computers, servers, devices, processors, nodes, processing circuitry, accelerators and/or computing devices may be used to execute the code and/or portions thereof. Many examples are possible.

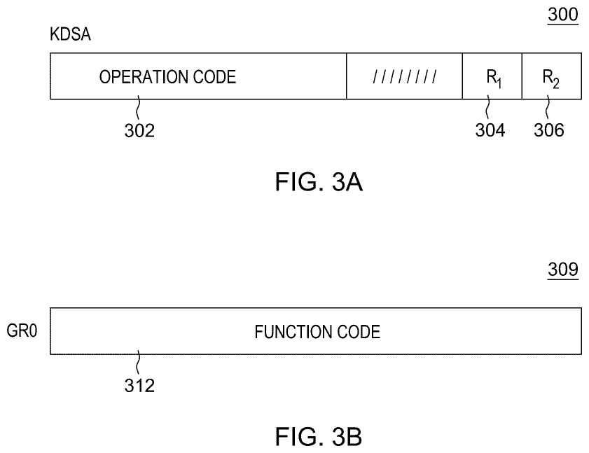

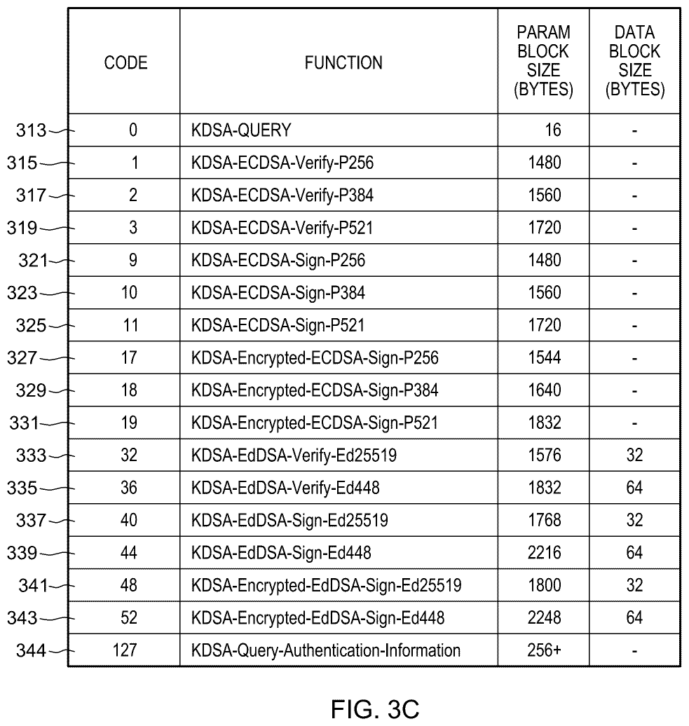

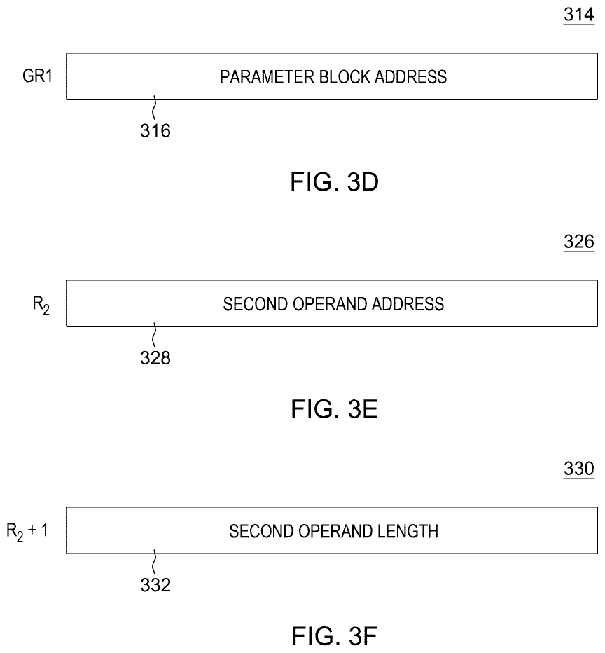

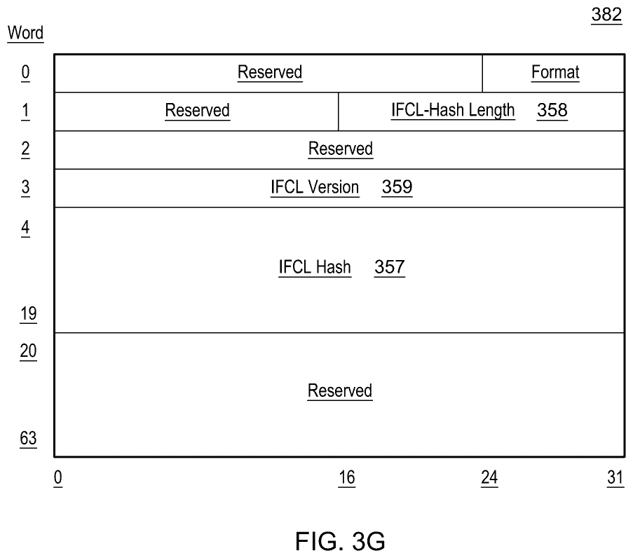

Examples of instructions to which machine code adds a function to an instruction to generate and return the instruction's IFCL hash and its version number are cryptographic instructions (e.g., CPACF instructions), such as a compute last message digest instruction and a compute intermediate message digest instruction; however, other instructions may also use control mode processing, including other cryptographic instructions, as well as non-cryptographic instructions. Many examples are possible. CPACF instructions are a non-limiting example of instructions that can be augmented with this additional function (e.g., FIG. 3C, KDSA-Query-Authentication-Information 344 for instruction KDSA), the respective CPACF instruction's Query-Authentication-Information function. Thus, program code (of a software application program) can utilize these instructions (for cryptographic functionality) provided that the instructions have been certified. And when an instruction is called by program code (e.g., software) executing on the machine, the program code can compare the hash from the instruction execution to the IFCL hash obtained from the CA, which can indicate whether a certification authority (CA) has certified the present version of the target instruction. Hence, the program code, including problem state software, can query a hash of the firmware level for each (e.g., CPACF) instruction, such that each hash is checked against the hash of the firmware level of the target (e.g., CPACF) instruction in the crypto certification library, and the software will use only those (e.g., CPACF) instructions whose hash of the firmware level of the target (e.g., CPACF) instruction have been certified by the CA. In an example where the instruction utilized is a CPACF instruction, below is a list of these CPACF instructions to which a first function (e.g., each CPACF instruction's Query-Authentication-Information function) can be added to enable the instruction to generate and return an IFCL hash and version. The instructions are listed below.
Cipher Message (KM)
Cipher Message With Chaining (KMC)
Cipher Message With Authentication (KMA)
Cipher Message With Cipher Feedback (KMF)
Cipher Message With Counter (KMCTR)
Cipher Message With Output Feedback (KMO)
Compute Intermediate Message Digest (KIMD)
Compute Last Message Digest (KLMD)
Compute Message Authentication Code (KMAC)
Perform Cryptographic Computation (PCC)
Perform Random Number Operation (PRNO)
Perform Cryptographic Key Management Operation (PCKMO)
Compute Digital Signature Authentication (KDSA)

One of the CPACF instructions to which a function can be added in some examples herein is a compute digital signature authentication instruction. In the examples, herein the KDSA-Query-Authentication-Information function of this instruction (e.g., KDSA instruction) can be modified. This instruction and the instruction group are provided as examples of a possible implementation of some aspects of the examples herein. Although some of the figures focus on the compute digital signature authentication instruction, these aspects, the IFCL and version can be implemented in other instructions and in the manner described herein and utilized as code components to return the IFCL and version to program code (e.g., software) executing on a machine.

The Compute Digital Signature Authentication instruction supports a plurality of authentication techniques and by integrating aspects of the examples herein, can also store and provide IFCL data to enable a program to determine whether it can utilize the plurality of authentication techniques. In one example, the instruction, referred to as a Compute Digital Signature Authentication instruction (KDSA), is used to generate a signature for use in signing a message to be transmitted and for verifying the authenticity of the message when received. The instruction is, for instance, part of a message security assist extension (e.g., Message Security Assist Extension 9) facility of the z/Architecture® hardware architecture, offered by International Business Machines Corporation, Armonk, N.Y. The message security assist extension provides support for elliptical curve cryptography authentication of a message, generation of elliptical curve keys and scalar multiplication. The Compute Digital Signature Authentication instruction provides support for the signing and verification of elliptical curves. Functions provided by the instruction include, for instance: KDSA-Query, KDSA-ECDSA-Verify-P256, KDSA-ECDSA-Verify-P384, KDSA-ECDSA-Verify-P521, KDSA-ECDSA-Sign-P256, KDSA-ECDSA-Sign-P384, KDSA-ECDSA-Sign-P521, KDSA-Encrypted-ECDSA-Sign-P256, KDSA-Encrypted-ECDSA-Sign-P384, KDSA-Encrypted-ECDSA-Sign-P521, KDSA-EdDSA-Verify-Ed 25519, KDSA-EdDSA-Verify-Ed448, KDSA-EdDSA-Sign-Ed25519, KDSA-EdDSA-Sign-Ed 448, KDSA-Encrypted-EdDSA-Sign-Ed25519, and KDSA-Encrypted-EdDSA-Sign-Ed448. These functions, except for the query function, are used in signing and verifying messages using various techniques for different National Institute of Standards and Technology (NIST) primes. The examples herein include the addition of another function to in order to generate and return the specified instruction's firmware code level hash and its version number. As aforementioned, programs can only utilize this function if the function is appropriately certified, which can be determined with the hash and the version number.

One example of the Compute Digital Signature Authentication (KDSA) instruction is described with reference to FIGS. 3A-3F. The instruction is executed, in one example, using a processor, such as a general-purpose processor. In the description herein, specific locations, specific fields and/or specific sizes of the fields are indicated (e.g., specific bytes and/or bits). However, other locations, fields and/or sizes may be provided. Further, although the setting of a bit to a particular value, e.g., one or zero, is specified, this is only an example. The bit may be set to a different value, such as the opposite value or to another value, in other examples. Many variations are possible.

In one example, referring to FIG. 3A, a compute digital signature authentication instruction, such as a Compute Digital Signature Authentication instruction 300, has a format, referred to as a register and register with an extended operation code (opcode) format, having, e.g., 32 bits. The instruction includes, for instance, an operation code field 302 (e.g., bits 0-15); reserved bits 304 (e.g., bits 16-23), which can contain zeros in order to maintain the operational compatibility of the program; one register field (R₁) 306 (e.g., bits 24-27); and another register field (R₂) 308 (e.g., bits 28-31). Although in this example there is one opcode field 302, in other examples, there may be more than one opcode field. For instance, there may be one opcode field at the beginning of the instruction format and one opcode field at the end of the instruction format. Other examples are also possible.

Referring to FIG. 3A, in one example, the format of a Compute Digital Signature Authentication (KDSA) instruction 300 is a format that denotes a register and register operation with an extended operation code (opcode) field. As an example, the instruction includes an operation code field 302 (e.g., bits 0-15) having an operation code indicating a compute digital signature authentication operation. Although in this example there is one opcode field 302, in other examples, there may be more than one opcode field. For instance, there may be one opcode field at the beginning of the instruction format and one opcode field at the end of the instruction format. Other examples are also possible. The instruction also includes a first register field (R1) 304 (e.g., bits 24-27), which is reserved, in one example, and should include zeros; and a second register field (R2) 306 (e.g., bits 28-31) designating a pair of general registers. The contents of a register designated by R2 field 306 specify a location of a second operand (in storage). The contents of R2+1 specify the length of the second operand. In one example, bits 16-23 of the instruction are reserved and should contain zeros; otherwise, the program may not operate compatibly in the future. As used herein, the program is the one issuing the instruction. It may be a user program or another type of program.

In an example of the Compute Digital Signature Authentication (KDSA) instruction 300, execution of the instruction includes the use of one or more implied general registers (e.g., registers not explicitly designated by the instruction). For instance, general registers 0 and 1 are used in execution of the instruction, as described herein. In one example, general register 0 contains various controls affecting the operation of the instruction, and general register 1 is used to provide a location of a parameter block used by the instruction.

As an example, with reference to FIG. 3B, a general register 0 (309) includes a function code field 312 that includes a function code. In one example, bit positions 57-63 of general register 0 contain the function code; in other embodiments, other bits may be used to contain the function code. Further, bits 0-31 of general register 0 are ignored, and bits 32-56 are reserved and should contain zeros; otherwise, the program may not operate compatibly in the future. When bits 57-63 of general register 0 designate an unassigned or uninstalled function code, a specification exception is recognized, in one example.

Function codes are utilized in the instruction to designate different functions. As discussed herein, certain of the examples include adding a function to handle IFCL information. Other examples of assigned function codes for the Compute Digital Signature Authentication (KDSA) instruction are shown in FIG. 3C and include, for instance: function code 0 (313) indicating a KDSA-Query function; function code 1 (315) indicating a KDSA-ECDSA-Verify-P256 function; function code 2 (317) indicating a KDSA-ECDSA-Verify-P384 function; function code 3 (319) indicating a KDSA-ECDSA-Verify-P521 function; function code 9 (321) indicating a KDSA-ECDSA-Sign-P256 function; function code 10 (323) indicating a KDSA-ECDSA-Sign-P384 function; function code 11 (325) indicating a KDSA-ECDSA-Sign-P521 function; function code 17 (327) indicating a KDSA-Encrypted-ECDSA-Sign-P256 function; function code 18 (329) indicating a KDSA-Encrypted-ECDSA-Sign-P384 function; function code 19 (331) indicating a KDSA-Encrypted-ECDSA-Sign-P521 function; function code 32 (333) indicating a KDSA-EdDSA-Verify-Ed25519 function; function code 36 (335) indicating a KDSA-EdDSA-Verify-Ed448 function; function code 40 (337) indicating a KDSA-EdDSA-Sign-Ed25519 function; function code 44 (339) indicating a KDSA-EdDSA-Sign-Ed448 function; function code 48 (341) indicating a KDSA-Encrypted-EdDSA-Sign-Ed25519 function; and function code 52 (343) indicating a KDSA-Encrypted-EdDSA-Sign-Ed448 function. The additional function, KDSA Query-Authentication-Information 127 (344), the KDSA instruction's Query-Authentication-Information function 127 (344), discussed herein stores information, specifically, the IFCL hash and version number, which can be utilized by the program code (e.g., software) to authenticate the running instruction's IFCL.

KDSA Query-Authentication-Information 127 (344) can include defined values. For example, utilizing special tagging, which is defined in the register, the first function can define the location, alignment, length, and/or format of the various values that comprise the IFCL information for the instruction. As illustrated in FIG. 3C, the parameter block size for the function in this example is a minimum of 256. FIG. 3G is an example of a format for a parameter block for the additional function described herein of which KDSA Query-Authentication-Information 127 (344) is an example.

In some examples herein, each function in various cryptographic instructions, including the KDSA instruction's Query-Authentication-Information function 127 (344) uses a parameter block, and the size of the parameter block depends, in one example, on the function. Example parameter block sizes for the functions are depicted in FIG. 3C, as well as example data block sizes, if applicable. Other function codes are unassigned in this example. Although example functions and function codes are described, other functions and/or function codes can be used. A parameter block is specified by, for instance, general register 1. In one example, referring to FIG. 3D, the contents of general register 1 (314) specify, for instance, a logical address 316 of the leftmost byte of a parameter block in storage. For instance, in the 24-bit addressing mode, the contents of bit positions 40-63 of general register 1 constitute the address and the contents of bit positions 0-39 are ignored. In the 31-bit addressing mode, the contents of bit positions 33-63 of general register 1 constitute the address, and the contents of bit positions 0-32 are ignored. In the 64-bit addressing mode, the contents of bit positions 0-63 of general register 1 constitute the address. In the access register mode, access register 1 specifies the address space containing the parameter block.

Returning to FIG. 3A, R2 field 306 designates an even-odd pair of general registers and is to designate, for instance, an even-numbered register other than general register 0; otherwise, a specification exception is recognized. As shown in FIG. 3E, the contents of a general register R2 (326) indicate a second operand address 328. For instance, the location of the leftmost byte of the second operand is specified by the contents of the R2 general register, depending on the addressing mode. In one embodiment, in the 24-bit addressing mode, the contents of bit positions 40-63 of general register R2 constitute the address of the second operand, and the contents of bit positions 0-39 are ignored; bits 40-63 of the updated address replace the corresponding bits in general register R2, carries out of bit position 40 of the updated address are ignored, and the contents of bit positions 32-39 of general register R2 are set to zeros. In the 31-bit addressing mode, the contents of bit positions 33-63 of general register R2 constitute the address of the second operand, and the contents of bit positions 0-32 are ignored; bits 33-63 of the updated address replace the corresponding bits in general register R2, carries out of bit position 33 of the updated address are ignored, and the content of bit position 32 of general register R2 is set to zero. In the 64-bit addressing mode, the contents of bit positions 0-63 of general register R2 constitute the address of the second operand; bits 0-63 of the updated address replace the contents of general register R2 and carries out of bit position 0 are ignored.

The number of bytes in the second operand location is specified in general register R2+1. As shown in FIG. 3F, the content of general register R2+1 (330) is used to determine the length 332 of the second operand. In one embodiment, in both the 24-bit and the 31-bit addressing modes, the contents of bit positions 32-63 of general register R2+1 form a 32-bit unsigned binary integer which specifies the number of bytes in the second operand; and the updated value replaces the contents of bit positions 32-63 of general register R2+1. In the 64-bit addressing mode, the contents of bit positions 0-63 of general register R2+1 form a 64-bit unsigned binary integer which specifies the number of bytes in the second operand; and the updated value replaces the contents of general register R2+1.

In the 24-bit or 31-bit addressing mode, the contents of bit positions 0-31 of general registers R2 and R2+1 remain unchanged. In access register mode, access register R2 specifies the address space for the second operand. In one example, the Edwards-curve operands are byte-wise ordered in the little-endian format and the second operand is likewise ordered within the second operand address space.

As noted above, FIG. 3G is an example of a parameter block 382 for the additional function described herein, a query authentication information function (e.g., KDSA Query-Authentication-Information 127 (344)). This function stores information that can be used by a program to authenticate a running instruction's IFCL (e.g., to generate and return the specified instruction's firmware code level hash and its version number). In some examples, the function is installed in a parameter block 382 (e.g., FIG. 3G) which can be referred to as a query-authentication-information parameter block (QAIPB). In this block, the condition code can be set to 0. Regarding the format of the parameter block, the query authentication information function, byte 3 of work 0 contains an 8-bit unsigned binary integer whose value specified the format of the parameter block itself. A format value of 0 (which is what is depicted in FIG. 3G), indicates a format-0-QAIPB. When this format is stored, the value of the field is set to 0.

In the parameter block 382 of the function, the hash of the IFCL is stored in IFCL Hash 357 while the firmware version number of the instruction is stored in IFCL Version 359. IFCL Hash 357 is words 4-19, contains the hash value of the IFCL and has its number of bytes specified by specified by the IFCL-Hash Length 358 field. The IFCL hash value is left aligned. When the IFCL hash is less than 64 bytes, the hash is padded with zeroes on the right. When the IFCL hash is larger than 64 bytes, only the leftmost 64 bytes of the hash are stored.

Referring to FIG. 3G, the IFCL-Hash Length 358 field is bytes 2-3 of word 1 and contains a 16-bit unsigned binary integer specifying the number of bytes of the IFCL hash stored in the IFCL Hash 357 field. When the IFCL hash is less than 64 bytes, the IFCL-Hash Length 358 field is set to the actual length of the IFCL hash. When the IFCL hash is larger than 64 bytes, the IFCL-Hash Length 358 filed is set to 64.

Also, in the parameter block 382 of the function, the IFCL Version 359 field in word 3 contains a 32-bit unsigned binary integer specifying the version number of the IFCL.

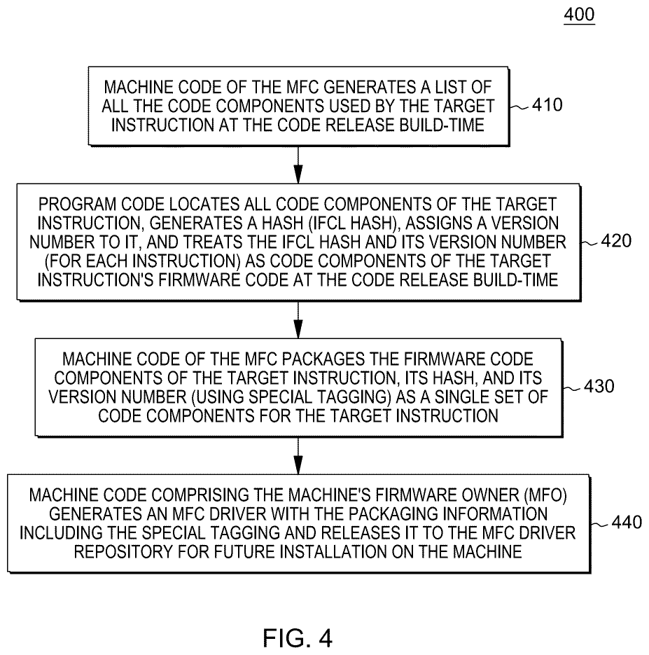

FIG. 4 is a workflow 400 which illustrates various aspects of the examples herein. To utilize an instruction to generate and return the instruction's firmware code level, the IFCL, this information is made available via the workflow 400 of FIG. 4. The program/software compares a hash from instruction execution to a hash obtained from a CA and stops using the instruction if the hash is not certified.

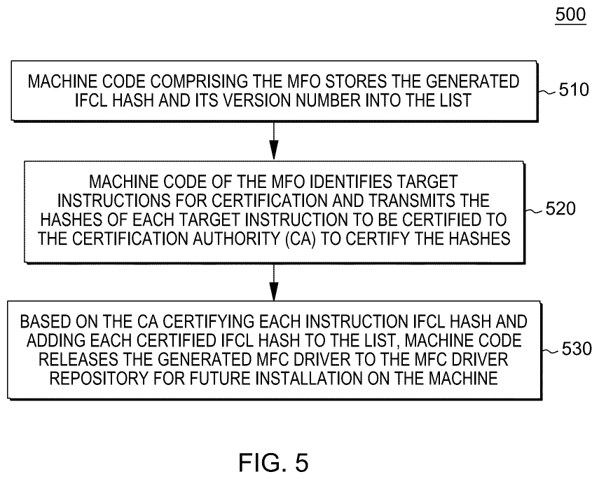

FIG. 4 illustrates how machine code in the examples herein generates and maintains a library to keep track of each (e.g., CPACF) instruction's IFCL hash and its version number, which were generated at a code release build-time. As illustrated in FIG. 4, for each target instruction (e.g., instruction potentially executed by software), the machine code of the MFC generates a list of all the code components used by the target instruction at the code release build-time (410). The machine code locates all code components of the target instruction, generates a hash, the IFCL hash, assigns a version number to it, and treats the IFCL hash and the version number (for each instruction) as code components of the target instruction's firmware code at the code release build-time (420). The machine code of the MFC packages the firmware code components of the target instruction, its hash, and its version number (using special tagging) as a single set of code components for the target instruction (430). Thus, the IFCL hash and its version number are treated in the computing system in the same manner as the other code components. Machine code comprising the machine's firmware owner (MFO) generates an MFC driver with the packaging information including the special tagging and releases it to the MFC driver repository for future installation on the machine (440). The machine code generating this driver and the information that its installation can provide is illustrated in greater detail in FIG. 5.

FIG. 5 illustrates an example workflow 500 of how a MFO generates a driver that, based on its installation on a machine, provides functionality that enables problem state software to query a hash of the firmware level of each instruction, check each hash against the hash of the firmware level of the target instruction in the library (e.g., a crypto certification library), and then utilize only instructions whose hash of the firmware level of the target instruction have been certified. The workflows 400 500 have some overlapping aspects but are separated herein for illustrative purposes only. In general, the machine code of the MFC would not release the driver before the workflow 500 of FIG. 5 is complete.

Referring to FIG. 5, for each instruction of the list (e.g., list of all the code components used by the target instruction at the code release build-time) that includes the IFCL, machine code comprising the MFO stores the generated IFCL hash and its version number into the list (510). This list can be understood as a target instruction IFCL list or, for example, a CPACF IFCL list. The machine code of the MFO identifies target instructions for certification and transmits the hashes of each target instruction to be certified to the certification authority (CA) to certify the hashes (520). The CA certified each instruction IFCL hash and adds it to a certified instruction IFCL hash list. Based on the CA certifying each instruction IFCL hash and adding each certified IFCL hash to the list, the machine code releases the generated MFC driver to the MFC driver repository for future installation on the machine (530). The machine code can update the IFCL hashes in the library based on the certifications received from a CA.

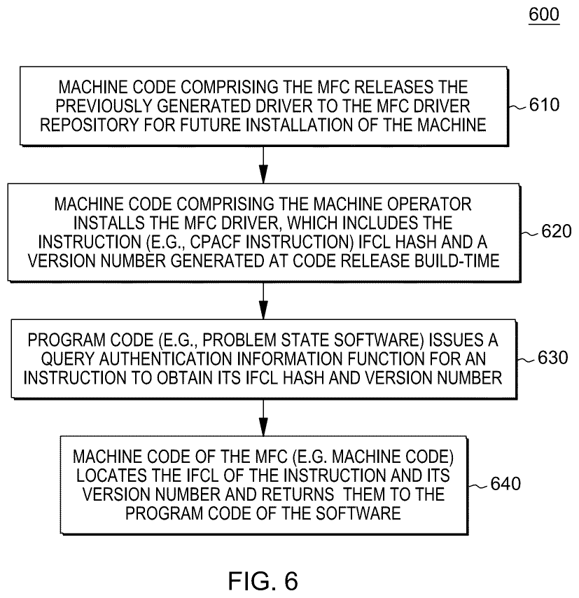

Once the MFC driver is installed of a machine, the machine code can utilize a single instruction to generate and return an IFCL so that software executing on the machine utilizes only instructions whose hash of the IFCL has been certified by a CA. FIG. 6 illustrates a workflow 600 the includes installation of the driver (generated by the MFO), and program code executing on the machine obtaining a target instruction's IFCL. In FIG. 6, machine code comprising the MFC releases the previously generated (e.g., FIG. 5) driver to the MFC driver repository for future installation of the machine (610). Machine code comprising the machine operator installs the MFC driver, which includes the instruction (e.g., CPACF instruction) IFCL hash and a version number generated at code release build-time (620). Program code (e.g., problem state software, code from a software application program) issues a query authentication information function for an instruction to obtain its IFCL hash and the version number of the hash (630). Responsive to the query by the program code of the software, the machine code of the MFC (e.g., machine code, firmware) locates the IFCL hash of the instruction and its version number and returns them to the program code of the software (640).

In some examples, the MFC locates the IFCL hash of the instruction and/or its version number in the machine's storage using easily identifiable special tags, markers, or pointers. In some examples, the MFC locates the IFCL hash of the instruction and/or its version number based on utilizing tags that were preserved when the driver was installed.

In some examples, program code (machine code and/or software depending on the application program and process utilized) can determine if the hash was created by a rogue program. To determine if a hash were created by a rogue program, the firmware code developer would use a program that takes an error hash as input and searches the hash library for a match and returns the outcome. Alternatively, the firmware code developer could check the error hash against the hash library for a match manually. Either way, this process can be performed offline at a time asynchronous with when the program encountered the error.

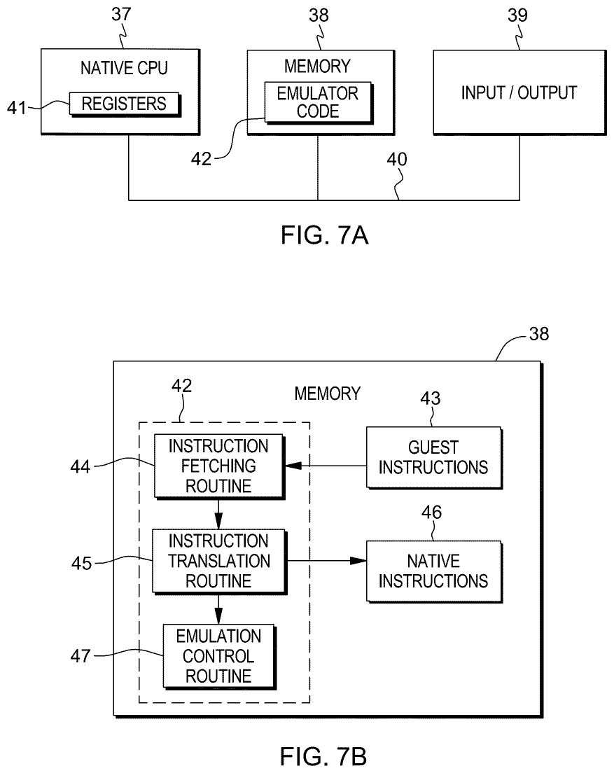

Although one or more examples of a computing environment to incorporate and use one or more aspects of the present disclosure are described herein, FIGS. 7A-7B depict another embodiment of a computing environment to incorporate and use one or more aspects of the present disclosure.

Referring, initially, to FIG. 7A, in this example, a computing environment 36 includes, for instance, a native central processing unit (CPU) 37 based on one architecture having one instruction set architecture, a memory 38, and one or more input/output devices and/or interfaces 39 coupled to one another via, for example, one or more buses 40 and/or other connections.

Native central processing unit 37 includes one or more native registers 41, such as one or more general purpose registers and/or one or more special purpose registers used during processing within the environment. These registers include information that represents the state of the environment at any particular point in time.

Moreover, native central processing unit 37 executes instructions and code that are stored in memory 38. In one particular example, the central processing unit executes emulator code 42 stored in memory 38. This code enables the computing environment configured in one architecture to emulate another architecture (different from the one architecture) and to execute software and instructions developed based on the other architecture.

Further details relating to emulator code 42 are described with reference to FIG. 7B. Guest instructions 43 stored in memory 38 comprise software instructions (e.g., correlating to machine instructions) that were developed to be executed in an architecture other than that of native CPU 37. For example, guest instructions 43 may have been designed to execute on a processor based on the other instruction set architecture, but instead, are being emulated on native central processing unit 37, which may be, for example, the one instruction set architecture. In one example, emulator code 42 includes an instruction fetching routine 44 to obtain one or more guest instructions 43 from memory 38, and to optionally provide local buffering for the instructions obtained. It also includes an instruction translation routine 45 to determine the type of guest instruction that has been obtained and to translate the guest instruction into one or more corresponding native instructions 46. This translation includes, for instance, identifying the function to be performed by the guest instruction and choosing the native instruction(s) to perform that function.

Further, emulator code 42 includes an emulation control routine 47 to cause the native instructions to be executed. Emulation control routine 47 may cause native central processing unit 37 to execute a routine of native instructions that emulate one or more previously obtained guest instructions and, at the conclusion of such execution, return control to the instruction fetch routine to emulate the obtaining of the next guest instruction or a group of guest instructions. Execution of the native instructions 46 may include loading data into a register from memory 38; storing data back to memory from a register; or performing some type of arithmetic or logic operation, as determined by the translation routine.

Each routine is, for instance, implemented in software, which is stored in memory and executed by native central processing unit 37. In other examples, one or more of the routines or operations are implemented in firmware, hardware, software or some combination thereof. The registers of the emulated processor may be emulated using registers 41 of the native central processing unit or by using locations in memory 38. In embodiments, guest instructions 43, native instructions 46 and emulator code 42 may reside in the same memory or may be disbursed among different memory devices.

An example instruction that may be emulated is a cryptographic instruction such as those discussed herein, in accordance with one or more aspects of the present disclosure. Other instructions are also possible.

The computing environments described herein are only examples of computing environments that can be used. One or more aspects of the present disclosure may be used with many types of environments. The computing environments provided herein are only examples. Each computing environment is capable of being configured to include one or more aspects of the present disclosure. For instance, each may be configured to implement control mode processing and/or to perform one or more other aspects of the present disclosure. Software and hardware performance is improved by eliminating extra code and executing time and preventing errors (e.g., for not initializing the unused fields with zeros).

One or more aspects of the present disclosure are tied to computer technology and facilitate processing within a computer, improving performance thereof. For instance, selective control mode processing enables a single architected instruction to be selectively configured to generate and return an instruction's firmware code level, which can include treating the an IFCL hash as code components and bundling it with the rest of the actual code components with special tagging to locate the IFCL hash code component efficiently. Other aspects, variations and/or embodiments are possible.

In addition to the above, one or more aspects may be provided, offered, deployed, managed, serviced, etc. by a service provider who offers management of customer environments. For instance, the service provider can create, maintain, support, etc. computer code and/or a computer infrastructure that performs one or more aspects for one or more customers. In return, the service provider may receive payment from the customer under a subscription and/or fee agreement, as examples. Additionally, or alternatively, the service provider may receive payment from the sale of advertising content to one or more third parties.

In one aspect, an application program may be deployed for performing one or more embodiments. As one example, the deploying of an application program comprises providing computer infrastructure operable to perform one or more embodiments.

As a further aspect, a computing infrastructure may be deployed comprising integrating computer-readable code into a computing system, in which the code in combination with the computing system is capable of performing one or more embodiments.

Yet a further aspect, a process for integrating computing infrastructure comprising integrating computer-readable code into a computer system may be provided. The computer system comprises a computer-readable medium, in which the computer medium comprises one or more embodiments. The code in combination with the computer system is capable of performing one or more embodiments.

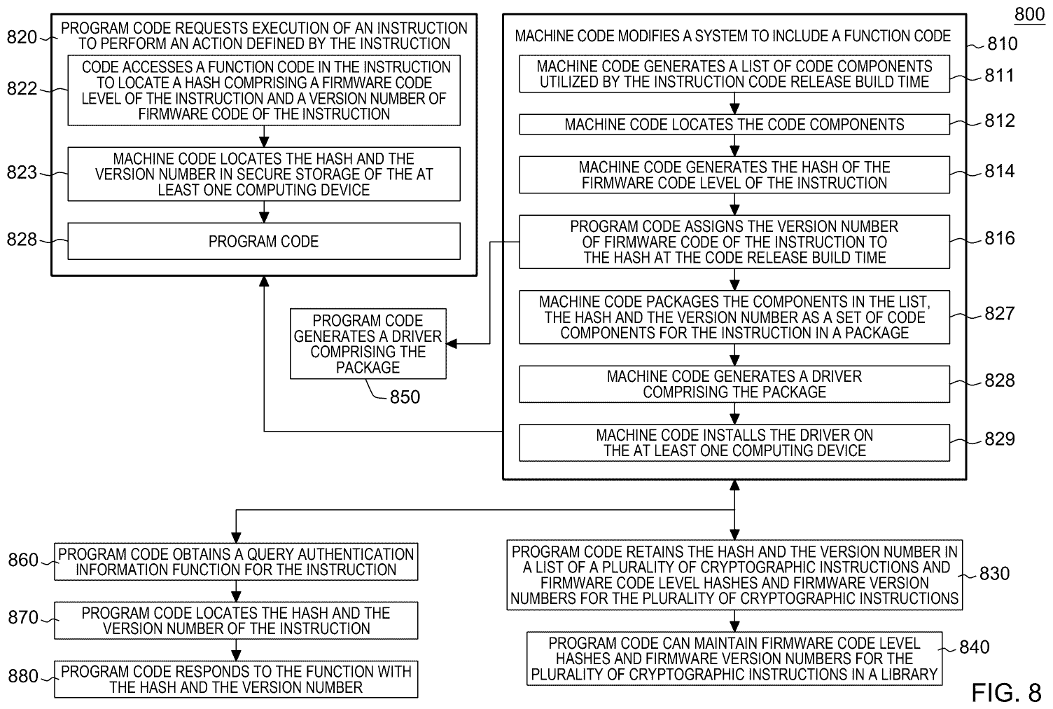

FIG. 8 is a workflow 800 that illustrates various aspects of some of the examples herein. As illustrated in this workflow 800, various aspects can occur in different orders and certain aspects can occur at the same time. In the of the workflow 800, certain examples here can also include machine code modifying a system so that an instruction includes a function code (810). The machine code generates a list of code components utilized by the instruction at code release build time (811). The machine code locates the code components (812). The machine code generates the hash of the firmware code level of the instruction (814). The machine code assigns the version number of firmware code of the instruction to the hash at the code release build time (816). As aforementioned, this version number is not part of the hash itself. The machine code packages the components in the list, the hash, and the version number as a set of code components for the instruction in a package (817). The machine code generates a driver comprising the package (818). The driver can be a machine firmware code driver. In some examples herein, both the package and the resultant driver include tagging to indicate a location of the hash, and the version number in the set of code components. The machine code installs the driver on the at least one computing device (829). In some examples, the driver can be delivered to a computing device and installed using an installation software, for example, as an update.

Once a system includes the instruction functionality described herein, software executing on the system (as otherwise accessing the system) can utilize the functionality provided (requesting execution of an instruction and using or ceasing use of an instruction based on its certification or lack thereof by a CA). In the workflow 800 illustrated in FIG. 8, program code (e.g., software executing on one or more computing devices) requests execution of an instruction to perform an action defined by the instruction (820). In some examples, the instruction comprises a Central Processor Assist Cryptographic Facility instruction. As part of this request for execution of the instruction (e.g., and an ultimate execution of the instruction), the machine code (e.g., firmware) accesses a function code in the instruction to locate a version number of firmware code of the instruction and to locate a hash comprising a firmware code level of the instruction (822). In some examples, accessing the function code in the instruction to the version number and the hash includes the machine code locating the hash and program code locating the version number in a storage of the at least one computing device (823). In some examples, the machine code locates the IFCL hash of the instruction and/or its version number in the machine's storage using easily identifiable special tags, markers, or pointers. Once the IFCL is provided to software, the software can progress or not, depending on the outcome. The program code of the application can determine, based on the firmware code level, that the instruction is certified by a certification authority. The program code (of the software) ceases utilizing the instruction if the hash is not certified (828).

In these examples, the machine code does not stop execution of an instruction. Rather, the program code of the software can compare a hash from an instruction issuance to a hash obtained from a CA and can cease utilizing the instruction if the hash is not certified. As discussed earlier, when an application program issues the instruction, computer operations include locating a version number of firmware code of the instruction and a hash comprising a firmware code level of the instruction. Computer operations include packaging the code components in the list, the hash, and the version number as a set of code components for the instruction in a package. Machine code of the MFO sends each IFCL hash to the certification authority (CA). Machine code of the MFC returns the CPACF IFCL hash and version number of the firmware code of the specified instruction to the program. The instruction can comprise a cryptographic instruction.

In some examples, the program code retains the hash and as well as the version number in a list of a plurality of cryptographic instructions and firmware code level hashes and firmware version numbers for the plurality of cryptographic instructions (830). For example, the program code can maintain firmware code level hashes and firmware version numbers for the plurality of cryptographic instructions in a library (840).

In some examples, the program code transmits a portion of the firmware code level hashes of the plurality of cryptographic instructions to a certification authority (850). The program code can complete this step after generating the hash (824).

In some examples, the program code obtains a query authentication information function for the instruction (860). The program code locates the hash and the version number of the instruction (870). The program code responds to the function with the hash and the version number (880). The program code issues the instruction if the hash is certified by a certification authority.

Although various embodiments are described above, these are only examples. For example, other instructions, instruction formats, operands, registers and/or instruction areas may be used. Further, other cryptographic algorithms may be used. Moreover, additional, less and/or other code may be used. Although particular code may be provided as an example of performing a particular operation or task, additional and/or other code may be used. Code may be combined and/or separated into code subsets. Many variations are possible.

Various aspects and embodiments are described herein. Further, many variations are possible without departing from a spirit of aspects of the present disclosure. It should be noted that, unless otherwise inconsistent, each aspect or feature described and/or claimed herein, and variants thereof, may be combinable with any other aspect or feature.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer program product comprising:
a set of one or more computer-readable storage media; and
program instructions, collectively stored in the set of one or more computer-readable storage media, for causing at least one computing device to perform computer operations including:
obtaining from an application program a request to execute of an instruction to perform an action defined by the instruction;
accessing a function code in the instruction to locate a version number of firmware code of the instruction and a hash comprising a firmware code level of the instruction;
locating the hash and the version number in a storage of the at least one computing device; and
providing the hash and the version number to the application program, wherein the application program issues the instruction if the hash is certified by a certification authority.

2. The computer program product of claim 1, wherein locating the hash and the version number comprises utilizing tagging.

3. The computer program product of claim 1, wherein the instruction comprises a cryptographic instruction.

4. The computer program product of claim 1, the computer operations comprising:
prior to obtaining the application program request, installing a driver on the at least one computing device.

5. The computer program product of claim 4, the computer operations comprising:
prior to the installing, generating the driver, the generating comprising:
generating a list of code components utilized by the instruction at code release build time;
locating the code components;
generating the hash of the firmware code level of the instruction;
assigning the version number of firmware code of the instruction to the hash at the code release build time;
packaging the code components in the list, the hash, and the version number as a set of code components for the instruction in a package;
generating a driver comprising the package; and
installing the driver on the at least one computing device.

6. The computer program product of claim 5, wherein the package comprises tagging to indicate a location of the hash, and a location of the version number in the set of code components.

7. The computer program product of claim 4, wherein the driver comprises a package and wherein installing the driver further comprises preserving tagging in the package at install, wherein the tagging indicates a location of the hash, and a location of the version number in the set of code components.

8. The computer program product of claim 7, wherein locating the hash and the version number comprises utilizing the tagging.

9. The computer program product of claim 5, the computer operations further comprising:
retaining the hash and the version number in a list of a plurality of cryptographic instructions and firmware code level hashes and firmware version numbers for the plurality of cryptographic instructions, wherein the instruction is a cryptographic instruction.

10. The computer program product of claim 9, the computer operations further comprising:
transmitting a portion of the firmware code level hashes of the plurality of cryptographic instructions to a certification authority.

11. The computer program product of claim 10, the computer operations further comprising:
maintaining firmware code level hashes and firmware version numbers for the plurality of cryptographic instructions in a library.

12. The computer program product of claim 11, the computer operations further comprising:
obtaining a query authentication information function for the instruction;
locating the hash and the version number of the instruction; and
responding to the function with the hash and the version number.

13. The computer program product of claim 4, wherein the driver comprises a machine firmware code driver.

14. The computer program product of claim 1, wherein the instruction comprises a Central Processor Assist Cryptographic Facility instruction.

15. The computer program product of claim 11, the computer operations further comprising:
determining if the hash was created by a rogue program, the determining comprising:
obtaining as input an error hash;
searching the library for a match; and
returning an outcome of the searching.

16. A computer system comprising:
at least one computing device;
a set of one or more computer-readable storage media; and
program instructions, collectively stored in the set of one or more computer-readable storage media, for causing the at least one computing device to perform computer operations including:
obtaining from an application program a request to execute of an instruction to perform an action defined by the instruction;
accessing a function code in the instruction to locate a version number of firmware code of the instruction and a hash comprising a firmware code level of the instruction;
locating the hash and the version number in a storage of the at least one computing device; and
providing the hash and the version number to the application program, wherein the application program issues the instruction if the hash is certified by a certification authority.

17. The computer system of claim 16, wherein the instruction comprises a cryptographic instruction.

18. The computer system of claim 16, the computer operations comprising:
prior to obtaining the application program request, installing a driver on the at least one computing device.

19. The computer system of claim 18, the computer operations comprising:
prior to the installing, generating the driver, the generating comprising:
generating a list of code components utilized by the instruction at code release build time;
locating the code components;
generating the hash of the firmware code level of the instruction;
assigning the version number of firmware code of the instruction to the hash at the code release build time;
packaging the code components in the list, the hash, and the version number as a set of code components for the instruction in a package;
generating a driver comprising the package; and
installing the driver on the at least one computing device.

20. A computer-implemented method comprising:
requesting execution of an instruction to perform an action defined by the instruction, wherein the executing the instruction includes:
obtaining from an application program a request to execute an instruction to perform an action defined by the instruction;
accessing a function code in the instruction to locate a version number of firmware code of the instruction and a hash comprising a firmware code level of the instruction;
locating the hash and the version number in a storage of the at least one computing device; and
providing the hash and the version number to the application program, wherein the application program issues the instruction if the hash is certified by a certification authority.

21. The computer-implemented method of claim 20, wherein the instruction comprises a cryptographic instruction.

22. The computer-implemented method of claim 20, the computer operations comprising:
prior to obtaining the application program request, installing a driver on the at least one computing device.

23. The computer-implemented method of claim 22, the computer operations comprising:
prior to the installing, generating the driver, the generating comprising:
generating a list of code components utilized by the instruction at code release build time;
locating the code components;
generating the hash of the firmware code level of the instruction;
assigning the version number of firmware code of the instruction to the hash at the code release build time;
packaging the code components in the list, the hash, and the version number as a set of code components for the instruction in a package;
generating a driver comprising the package; and
installing the driver on the at least one computing device.

24. A computer program product comprising:
a set of one or more computer-readable storage media; and
program instructions, collectively stored in the set of one or more computer-readable storage media, for causing at least one computing device to perform computer operations including:
generating and installing a driver on the at least one computing device, the generating and installing comprising:
generating a list of code components utilized by an instruction at code release build time;
locating the code components;
generating a hash of the firmware code level of the instruction;
assigning a version number of firmware code of the instruction to the hash at the code release build time;
packaging the code components in the list, the hash, and the version number as a set of code components for the instruction in a package
generating the driver, wherein the driver comprises the package; and
installing the driver on the at least one computing device.

25. A computer system comprising:
at least one computing device;
a set of one or more computer-readable storage media; and
program instructions, collectively stored in the set of one or more computer-readable storage media, for causing the at least one computing device to perform computer operations including:
generating and installing a driver on the at least one computing device, the generating and installing comprising:
generating a list of code components utilized by an instruction at code release build time;
locating the code components;
generating a hash of the firmware code level of the instruction;
assigning a version number of firmware code of the instruction to the hash at the code release build time;
packaging the code components in the list, the hash, and the version number as a set of code components for the instruction in a package
generating the driver, wherein the driver comprises the package; and
installing the driver on the at least one computing device.
